(19) United States
(12) Patent Application Publication
(10) Pub. No.: US 2009/0164382 A1
(43) Pub. Date: Jun. 25, 2009

(54) SYSTEM FOR MANAGING MULTIPLE CREDIT ACCOUNTS

(76) Inventor: Joseph SALLY, Los Angeles, CA (US)

Correspondence Address: STEFAN KIRCHANSKI, VENABLE LLP 2049 CENTURY PARK EAST, 21ST FLOOR, LOS ANGELES, CA, 90067, US

(21) Appl. No.: 12/360,024

(22) Filed: Jan. 26, 2009

Related U.S. Application Data
(63) Continuation of application No. PCT/US07/74323, filed on Jul. 25, 2007.
(60) Provisional application No. 60/820,436, filed on Jul. 26, 2006.

(51) Int. Cl. H04L 9/00

(52) U.S. Cl. 705/67; 705/65

(57) ABSTRACT

In an improved method and system for managing consumer credit accounts a consumer registers a plurality of credit accounts through a secure web page establishing a priority of accounts in the process. The web page aggregates data from all of the registered accounts and a single credit card or device is issued to access the aggregated accounts. The single card is used at points of sale like an ordinary credit card except that it requires a password like a debit card. When a purchase is made the request is relayed to the credit account that has the top priority and sufficient available credit. A single card can access a plurality of separate credit accounts so there is no need to carry multiple cards. If the single card is stolen, it can be rapidly inactivated with a single call. It will not be necessary to cancel the underlying accounts.

### CROSS-REFERENCE TO PRIOR APPLICATIONS

This application is a continuation of PCT/US2007/074323, which application designated the U.S., which in turn was based on U.S. Provisional Patent Application No. 60/820,436, filed on Jul. 26, 2006, and claims benefit and priority from both applications which are incorporated herein in their entirety by reference.

### U.S. GOVERNMENT SUPPORT

Not Applicable

### BACKGROUND OF THE INVENTION

1. Area of the Art

The present invention concerns the area of consumer credit and more particularly a new credit card product and system for securely managing a plurality of separate credit card accounts.

2. Description of the Background Art

Managing personal credit has become increasingly difficult because there has been an explosion in the varieties of credit vehicles available to the consumer with a concomitant increase in identity theft and related schemes that take advantage of this wide availability of consumer credit to defraud both the consumer and the companies that extend credit to the consumer. There have been rather feeble attempts to improve credit card security mostly through relatively lame credit card registry services that promise to cancel a user's credit cards as soon as the user reports misuse and to then automatically reapply for new replacement cards. This approach is reactive rather than proactive and seems a bit like closing the barn door after the cow has already escaped. What is really needed is a way for the consumer to prevent multiple credit cards from falling into the wrong hands and readily to control and monitor the use of the various accounts. While it is true that a number of credit card companies do have sophisticated monitoring programs looking for fraudulent credit card use, the individual consumer has little control over these programs and cannot directly use them to his or her benefit.

Of course, the simplest solution is for each consumer to have only a single credit account. This would make it much easier to monitor that one account for fraudulent or erroneous transactions. With only a single card it would be more readily apparent when the card had “gone missing.” However, it seems unlikely that most consumers would embrace this solution. Each different credit account has its own special advantages and disadvantages, and these constantly change with time. One card may offer airline miles for purchases. Another card may offer special bonuses for certain types of purchases but only at certain places or times. There may be competition between features. One card may yield a cash rebate while another competing card offers free rental car insurance on rental car transactions. It may turn out that the amount of cash rebated on a rental car transaction is less than the cost of the insurance offered by the rival card. In that case the rental car purchase should be made with the competing card while the hotel fee for the same trip should be paid with the cash rebate card. This situation requires the consumer to carry at least two cards. Yet another card may allow low interest balance transfers for a limited time so that it would be advantageous to transfer as many balances to that card while the low interest offer is valid. But how is a consumer to keep track of the offers and features and make the most efficient use of multiple credit cards? Even if a consumer miraculously learned all the rules and temporary offers, taking full advantage of them would require carrying a full knapsack of credit cards around so as to have the correct card at the correct moment-hardly a way to protect one's cards from theft.

### SUMMARY OF THE INVENTION

The present invention is a system and method for managing credit cards so as to improved security (e.g., decrease theft and fraud) and to allow a consumer to take full advantage of special credit card offers. In the inventive system a single card takes the place of a plurality of separated cards while preserving the consumer's ability to access and manage all of the separate accounts as if the actual separate credit cards were present. The single SAC (“Select-A-Card) special credit card is linked to the plurality of cards by means of a secure web site where the consumer registers all the separate cards and links them to the single SAC. By means of the web site the consumer also sets up a priority list that controls which credit account will be used first under various sets of conditions. The registration process includes entering password information for each account so that the system is able to access each account and maintain a record of the available balances, etc.

The consumer subsequently uses the SAC credit card like an ordinary credit card except that the preferred embodiment requires that the SAC card be password protected like a debit card. When the purchase is made, the system directs the sale to the credit card account having both the highest priority (as established by the user during the registration process or during a later update) and having sufficient available credit balance. Thus, the system achieves at least two ends—the preferred account is accessed first and attempted “over the credit limit” charges are never made. This significantly lowers the possibility of a purchase being declined. If the preferred account does not authorize (for whatever reason) the charge will be tried on the next account in the preference order. Again, this decreases the likelihood of a charge being declined.

While the inventive card can be used at an ordinary point of sale, the inventive card and system can also be accessed through special Internet connect point of sale terminals. This type of card use allows the consumer to access most of the features available through the ordinary web site. This type of access also allows the system to offer special offers to the consumer. In many cases the offers will be keyed to the details of the purchase being made (type of goods, etc.) as well as the overall demographics and purchasing history of the consumer. The offers can be incentives offered specially to the SAC card user but can also be rebates and other offers made to all consumers. Because the system has access to all the consumer's data, eligibility for rebates, etc. can be determined in advance so that only valid rebates are shown. When a rebate is accepted, the system can automatically take care of the fulfillment task. The system can also take advantage of offers made in return for opening new accounts. Because the system has all of the required data available, new credit accounts can be instantly opened upon authorization by the consumer.

The invention represents a secure way of managing multiple credit accounts and automatically taking advantage of a variety of special offers. Should the inventive card be lost, none of the underlying accounts are compromised. A single call disable the inventive card & a replacement card linked to the underlying accounts can be provided immediately.

### DESCRIPTION OF THE FIGURES

FIG. 1 is flow chart showing the overall steps of setting up and using a SAC card.

FIG. 2 is a flow chart showing the same process as shown in FIG. 1 except that there is insufficient credit in the priority account for the transaction to complete.

FIG. 3 is a flow chart showing the same process as shown in FIG. 1 except that the consumer selects the credit account to be used at the point of sale (POS).

FIG. 4 is an exemplar of a POS screen that allows the consumer to select the credit account to be used.

FIGS. 5A-D show a more detailed flow chart illustrating the process of using the web site referenced in FIG. 1 whereby the user interacts with the inventive system.

FIGS. 6A-B shows a more detailed flow chart illustrating the POS process referenced in FIG. 1.

FIGS. 7A-B show a flowchart illustrating the process of FIG. 6 using a radio frequency device.

FIGS. 8A-B shows a flowchart illustrating the process used to interact with the credit card provider.

FIGS. 9A-B show a flowchart of the process that the credit card provider uses to interact with the inventive system.

FIGS. 10A-B show a flowchart of the process that a vendor uses to interact with the inventive system.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a method to manage multiple consumer credit card accounts.

The problems introduced above are solved by means of a credit card system wherein a card device, (called the Select-A-Card or “SAC” by the inventor) is linked to a software system. The inventive system includes a single credit card/credit device that is linked to and effectively contains all a consumer's credit/debit and specialty cards. As used herein a traditional “credit card” is a simple (usually plastic) card that acts as a token for a credit account and usually contains a machine-readable account number and other data for verification and account access information (e.g., a magnetic strip). A traditional credit card is entirely passive in terms of the data it can present to an interrogating system. As used herein a “credit device” is a device that is generally in the form of a credit card (but may take other forms) and is active rather than passive. An example of a credit device is a “smart card” containing an embedded microchip for data storage and for making an active response to an interrogating system. This response is made by means of RFID (Radio Frequency Identification), WiFi (Wireless Fidelity-IEEE 802.11b wireless networking), Bluetooth, IrDA (Infrared Data Association) networking or similar data transmission and networking protocols and technologies. The meaning of “credit card” and “debit card” is well-known. By “specialty card” is meant any credit card/device issued by a particular vendor and useable primarily at that vendor's establishments. Examples would be gasoline or department store credit cards. Specialty cards also include “club” or membership cards whereby a given merchant gives rebates or special prices to members identified by holding the card. Of course, there can be credit cards having properties intermediate between specialty cards and traditional credit cards.

As will become apparent, the SAC card eliminates the need for a consumer to carry multiple cards at any given time. Instead of carrying a plethora of separate cards, the consumer carries at most a single SAC card which operates as a token representing all of the credit cards owned by the consumer. The SAC card is effectively linked to the individual accounts and operates in conjunction with a secure web site, for registering users and their accounts to establish the linkage. When a consumer first signs up for the SAC card, he or she logs into the web site and establishes an account in the manner usual to most online merchants. That is, personal information including name, address, contact (phone and email) is entered and a password is established for the account. At that point payment for the basic account is made (different revenue models are applicable to the invention, but in most cases there will be some type of annual fee for the service). A credit card or credit device is then prepared for the account and delivered to the account owner. The SAC card or device has the same properties of a regular credit card or device (account number, security code, etc.) and is used in much the same manner as an ordinary credit card.

Once a consumer has established a SAC account, the consumer is able to start registering his or her credit cards. The registration process consists of entering the account number and related authorization information (expiration date and security code, name, billing address, etc.) as may be appropriate for the account as well as the type of card and the identity of the card issuer. Once this information has been entered, the web site is in a position to make online purchases or fund transfers to the SAC account. Once the information has been entered, a logged in user can correct or modify the information for the registered accounts but cannot see any of the credit card data. The user is presented with a list of registered accounts with all except the last four digits masked so that the user can identify the accounts. The other critical information such as expiration date and security code is masked, but the user can reenter that information to make changes when the cards are periodically replaced by the issuer. Each account also shows the most recent edit date so that the user can determine which accounts have been more recently updated.

It will become apparent that some of the functions of the system involve distributing charges so as to access one of a plurality of accounts according to certain predetermined factors. To best accomplish this it is most advantageous for the system to “know” the current balance of each account as well as the credit limit for each account so as to always keep track of the amount of available credit. This information can be provided in at least two different ways. Virtually all credit cards presently provide online services whereby a legitimate user can view an account, its credit limit, balance and recent charges. In cases where the user has already established access to such an online service for a particular account, the access information for the account can be provided during the registration period. Thereafter, the inventive system will periodically and automatically log into the online system and retrieve a current version of balance and credit limit. Alternatively, because the inventive system provides significant advantages (particularly in controlling fraud) to the credit card companies, the credit card companies will be willing to provide current balance and credit line information to the system after receiving authorization from the account owner (providing such authorization can made be part of the credit account registration process).

The consumer uses the SAC credit card or credit device like an ordinary credit card except that it is password protected like a debit card. This acts as an additional level of security. At an ordinary Point of Sale (POS) swiping the card invokes the normal verification system as used for a debit card; however, the request for fund transfer is directed to the SAC servers rather than to those of the ordinary credit card transaction clearing house. Alternatively, the request can pass to the regular clearing house which in turn relays the request to the SAC servers. To appreciate how the system functions let us compare a situation where the consumer has registered only a single credit card with the SAC web site with a situation where the consumer has registered three different credit cards with the web site. In the first instance after the system has authorized the basic transaction (i.e., ensured that the password is correct), the fund transfer request is compared to the available credit in the registered account. If there are funds available in the registered account, the request is relayed to the original credit card company who then authorizes the transfer. In the unlikely event that the credit card company does not authorize the transaction, the POS terminal receives and displays a “declined” message. When the transaction is authorized, the funds are transferred from the credit card company into the SAC account which then transfers the funds to the merchant's account. Alternatively, the SAC request to the credit card company may contain the necessary routing information so that the credit card company can directly transfer the funds into the merchant's account. The procedure followed may vary depending on the credit card clearing house used by the merchant and the type of account maintained by the merchant. In all cases there will be a real-time authorization, but in some operations actual fund transfer and reconciliation happen periodically—for example daily, except perhaps, on weekend or holidays.

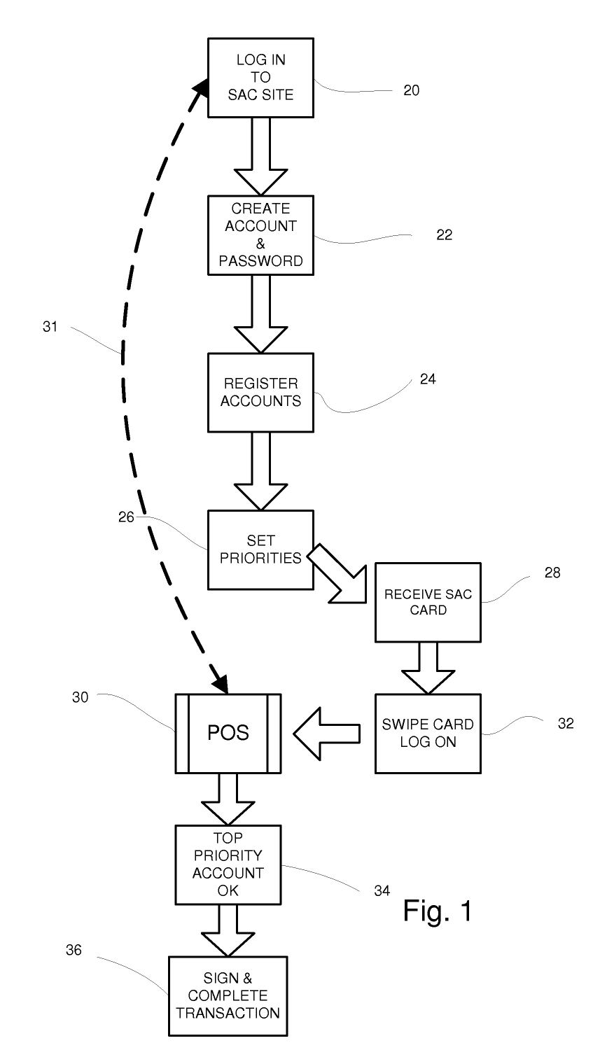

FIG. 1 is a flow chart showing the overall steps in setting up and using the SAC card in an implementation where the SAC card operates by means of its own web site. At a first step 20 the consumer logs into the web site and creates an account and password at a next step 22. At this step name, address and security data are provided to the system as is common to most online merchant systems. At a following step 24 the user registers a plurality of credit accounts and at a next step 26 establishes priorities and special instruction for using the accounts. The SAC system then queries the credit card companies behind the registered accounts to ascertain the validity of the accounts and their current credit limits and balances which information is stored in secure databases maintained by the SAC system. This process will be illustrated in detail below. The balances and limits are periodically updated. At the next step 28 the consumer receives the SAC card in the mail and thereafter uses it in place of ordinary credit cards. When making a purchase at a POS in step 30, the consumer swipes the card and logs in (i.e., gives the correct password) at step 32. Thereafter the purchase is processed similarly to an ordinary credit card purchase except that the top priority credit account (step 34) receives the charge provided that account has sufficient available credit. The sale is completed at step 36. It is possible for the SAC system to rely entirely on its own databases and not use a traditional credit card clearing service for authorization. More likely, as detailed below, step 34 will include a process whereby the credit card company or a clearing house is contacted automatically to verify the authorization.

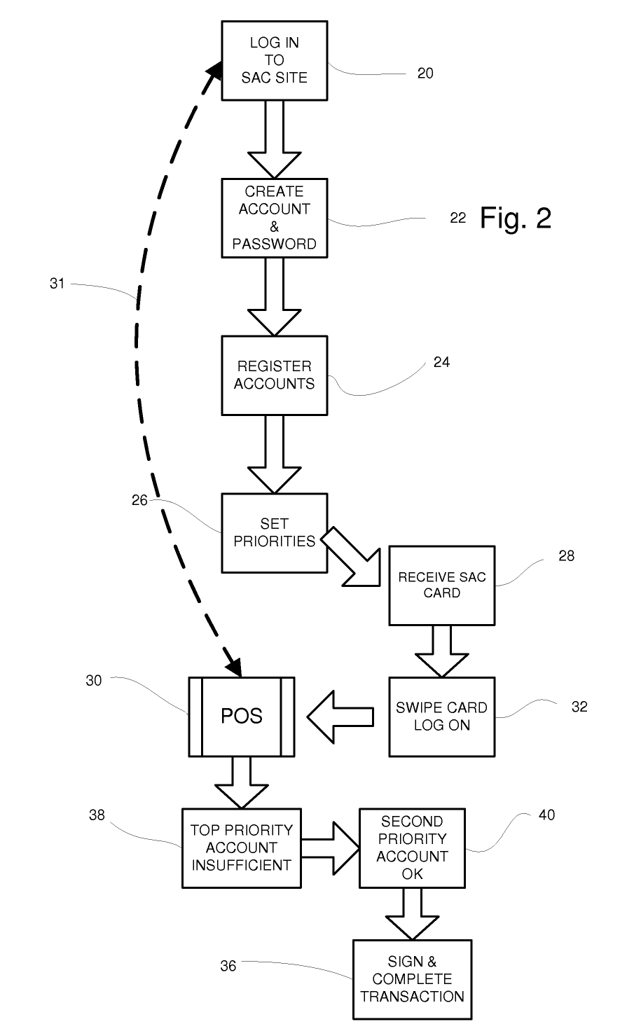

FIG. 2 shows a situation where there is insufficient credit available in the priority account at step 38. Again, this lack of sufficient credit might be determined based on the SAC databases or directly from a query sent to the credit card provider or its representatives. At step 40 the transaction completes through another registered account having sufficient available credit.

In the situation where the consumer has registered multiple accounts with the web site, the process works slightly differently. In registering multiple credit accounts the user is given the choice of prioritizing the accounts. For example, the user may have a rebate account that the user would like to use until it is maxed out (or until it reaches a certain balance that the user preselects). In that case the SAC server that receives the request (as described above) checks the priority order of the accounts and verifies that the preferred account has adequate available credit to cover the funds request. If it does a request is sent to the credit card company and the transaction proceeds as described above. Should there be insufficient available credit in the preferred account or should the preferred account not authorize the transaction, the SAC server will relay the request to the second account in the list and so on. Thus, a great advantage of the system is that the consumer has control over which account is used (without having to carry a plethora of cards) and is also often spared the embarrassment of having a maxed out card declined because the SAC system automatically tries the request on a number of accounts until available credit is found. Although three cards have been used in this example, there is no practical limit to the number of cards that can be registered through a single SAC account—and accessed with a single SAC credit card or credit device.

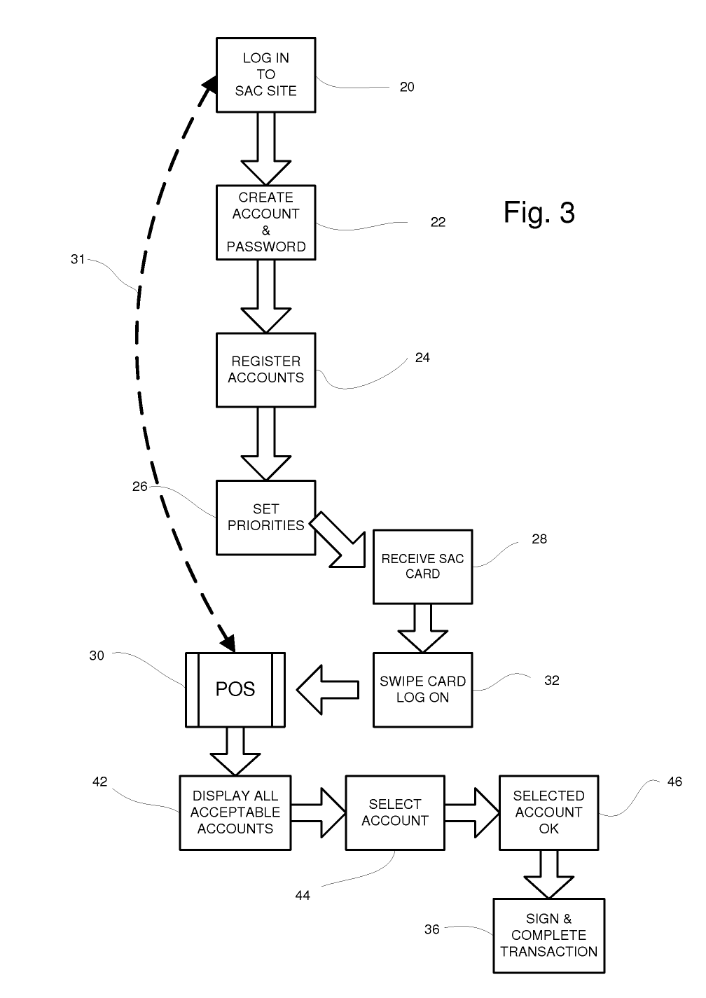

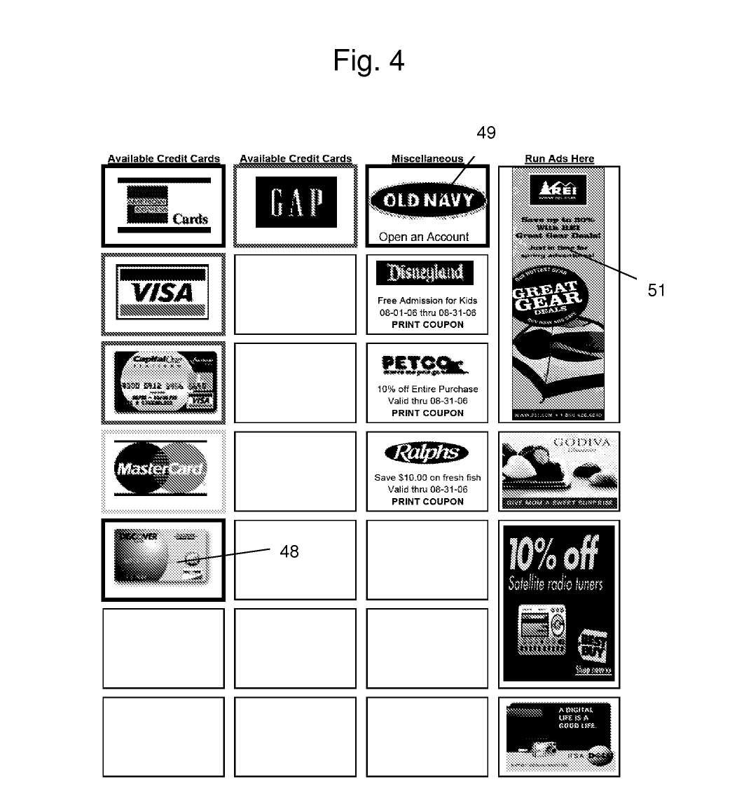

Although the SAC card can be used with “ordinary” POS systems as explained above, it is also possible for the POS system to access a special version of the SAC web site to provide a variety of extra services. At the present time some POS systems are Internet enabled and can be readily adapted to take advantage of the SAC web sites. Also, many existing POS systems are networked through an in-house computer system that can be adapted to allow Internet access. It seems likely that more and more merchant systems will become Internet savvy. When the POS system is Internet connected, swiping a SAC card logs the user into the merchant's SAC account approval site. The approval site will carry out approvals as explained above. However, the SAC site instantly recognizes the given SAC account and presents relevant information to the user. For example icons representing all of the registered accounts can be presented. FIG. 4 shows an exemplar of a POS screen that allows the SAC user to select any of a plethora of registered accounts 48. The accounts can be displayed to indicate preselected priority or according to the amount of available credit (for example by a color coding process—e.g., green/yellow/red—not shown). In addition, special incentive offers 49 from the merchant or from the credit card providers can be displayed. General purpose advertisements 51 can also be displayed. Because SAC and the various registered credit card providers have data concerning the purchasing habits of the user, the offers 49 and advertisements 51 can be customized for each user. The user can query the accounts as to available credit and can chose which account is to be charged, thereby overriding any account priority scheme that was then in force. These results can be affected by means of touch screen displays, displays with pull-down menus, or even displays that have scroll screens—the possibilities are virtually limitless. Because the SAC approval site is also aware of the merchant's identity the display can be configured to show only the credit/debit accounts that the merchant accepts and that have credit available. This eliminates guesswork on the part of the consumer, as to whether or not a merchant accepts American Express or Discover. It also eliminates the embarrassment of giving a merchant a credit card that is not honored by the merchant or is overdrawn. FIG. 3 shows a system implementation similar to that of FIG. 2 except that the display shows the available accounts and information concerning available credit at step 42. At step 44 the user selects the account to be used; the selected account is authorized in step 46 and the transaction completes in step 36.

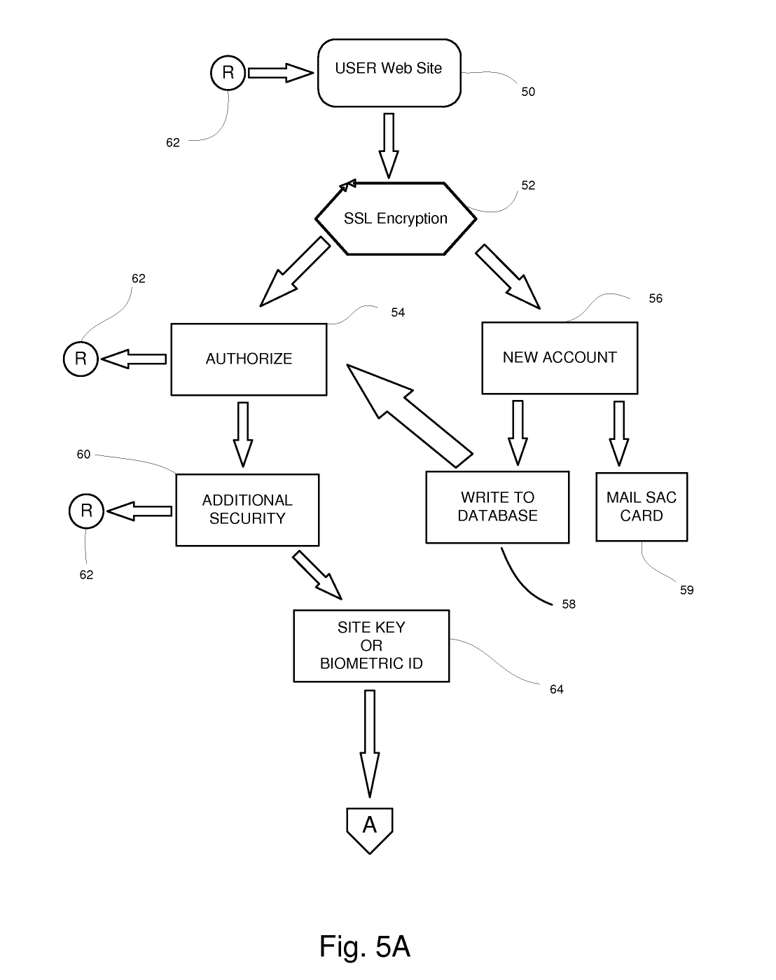

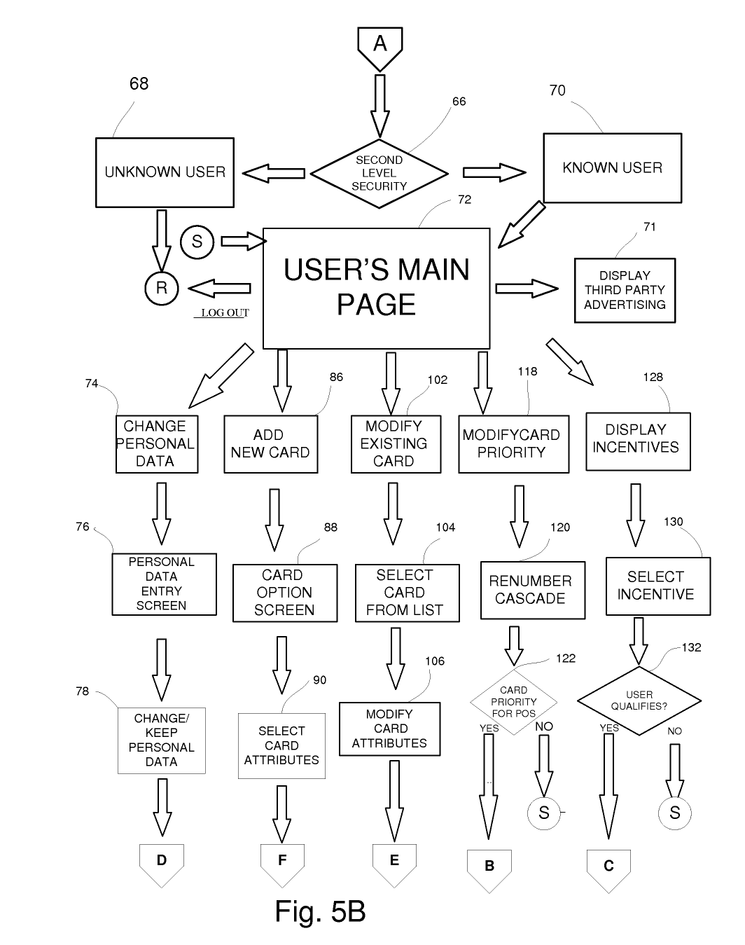

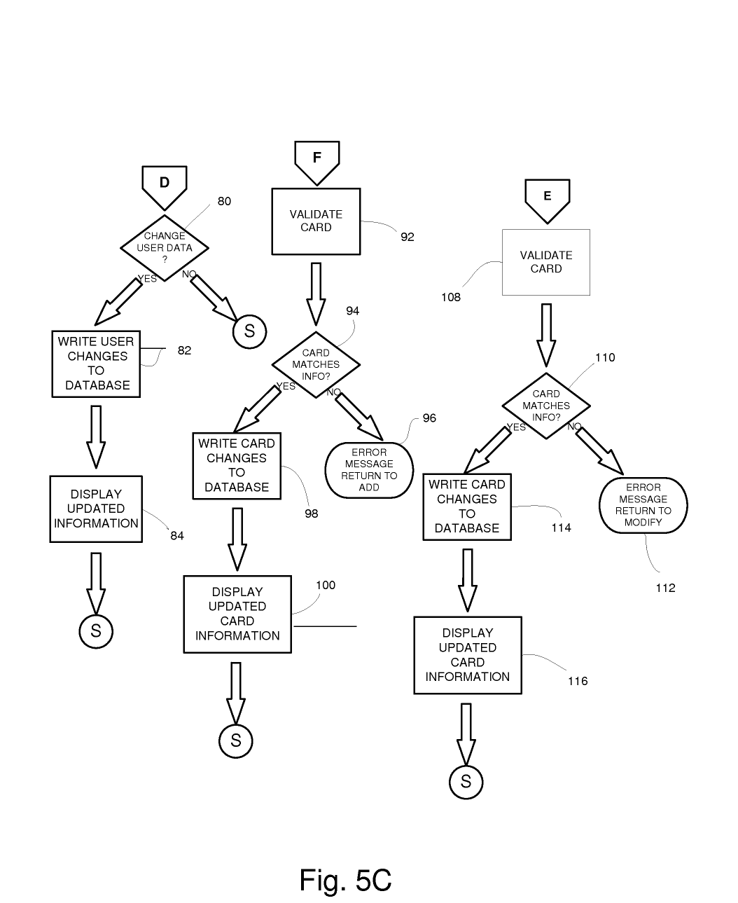

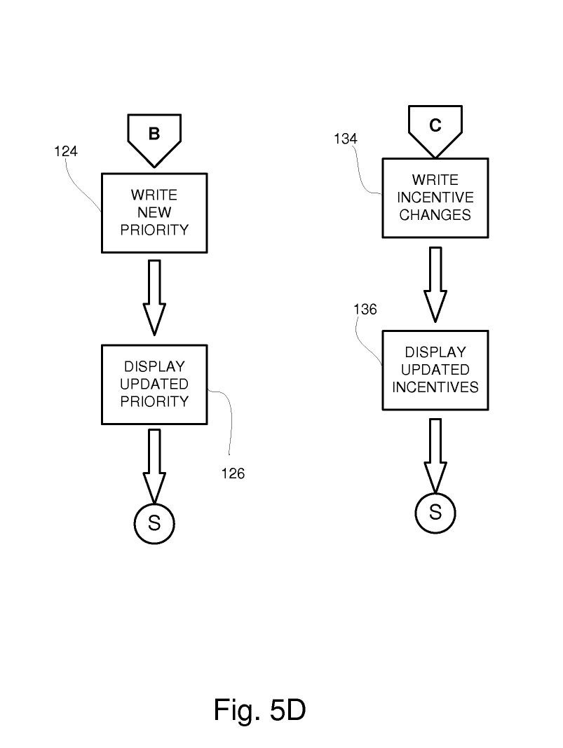

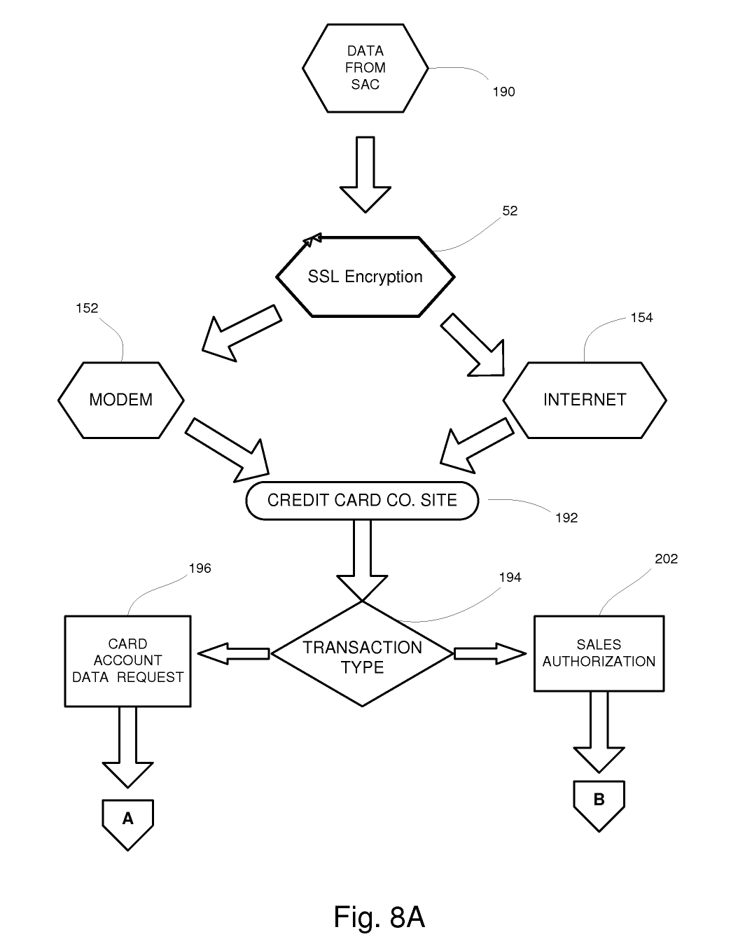

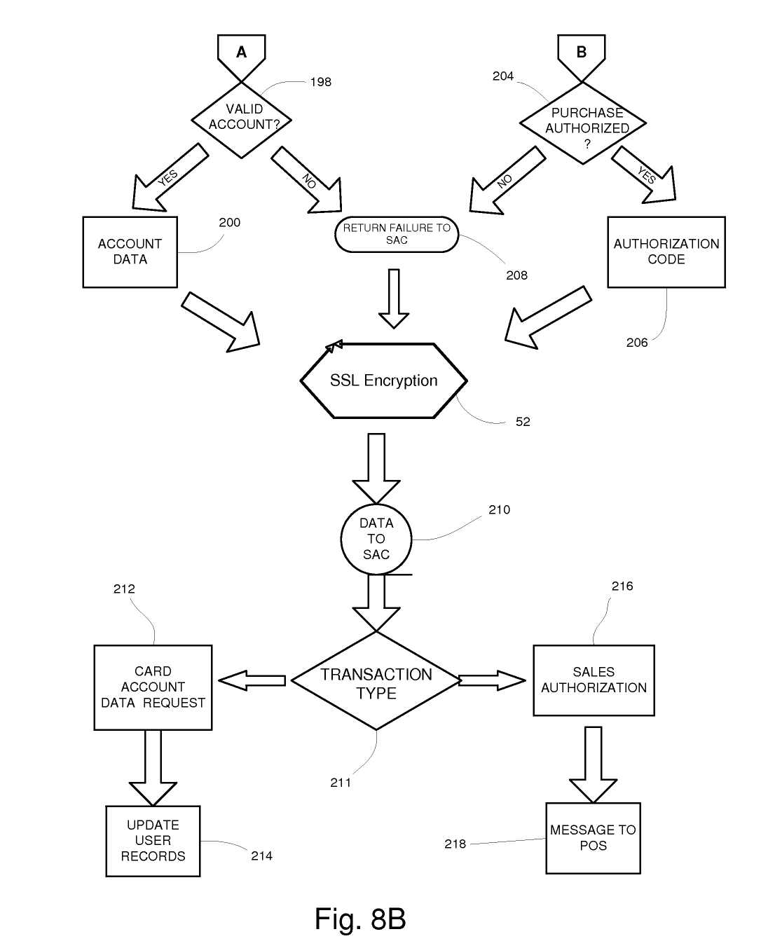

FIG. 5 is a flow diagram showing the steps in the process underlying a user SAC website 50. The user logs into the web site at step 50 (FIG. 5A) using an ordinary Internet browser and a personal computer or other Internet accessible device. All communication with the web site 50 is SSL (Secure Sockets Layer) encrypted (step 52); SSL is the current technology for secure web-based transactions. Of course, such security technology will evolve with time and it is understood that the encryption step will use the then current best technology. The web site 50 can be used for two different functions. First in step 56 a new user establishes an account for the first time. This involves entering name and address information as well as a new password and secondary security information. Such information can include a site key (an image or phrase displayed by the site at login so that the user can be certain the site is authentic) as well as biometric data (mother's maiden name, first automobile, etc.) used by the site to ensure the authenticity of the user. In step 56 the system does some security checking to make certain that public records agree. If this check is passed, the new account data is recorded (step 58) and the new user is given the option to login through step 54. After additional checking a new SAC card is sent to the new user at step 59. It will be appreciated that in most cases the new user will go on (see below) to register cards. If problems occur with SAC's authorization of the registered card with the credit card provider (see FIG. 8), then the authenticity of the user may be called into question. This may cause the new account to be cancelled and the SAC card mailing cancelled or may require additional interaction with the user to resolve the problem.

Apart from establishing new accounts, the major function of the web site 50 is to manipulate the user's account. To do this a user is presented with a first authorization step at step 54. This consists of the typical username and password challenge. If the user answers correctly, they are passed on to an additional security step 60. If the user is not authorized at step 54, they are returned (step 62) to the initial web site 50. The additional security step 60 can include checking user IP addresses and “cookies.” When this step is completed, the user may face additional checks in a site key/biometric data step 64. Then the user passes on to the second level security step 66 (FIG. 5B) where the biometric data is acted upon. An unknown user passes through step 68 (error messages, etc.) and back to initial web site 50. A known user passes through step 70 and is directed to the User's Main Page (step 72) from which all the desired account manipulations can be made. At the Main Page 72 third party advertising is displayed to the user (step 71). This is an additional source of revenue to SAC, but the types of offers displayed are carefully selected based on the user's demographics. Since this all happens in Internet space, the user can readily click through the offers to take advantage of them.

The user can select to update or change personal data (step 74) which data includes address, user name and password. The user passes to a personal data entry screen (step 76) which displays all of the current personal data from the SAC databases. At step 78 the user is allowed to edit any of the current personal data. Control passes to decision step 80 (FIG. 5C) where the user is redirected to the Main Page 72 if no personal data has been changed. If there has been a data change, the changes are written to the databases at step 82 and the updated data are displayed at step 84; thereafter the user is redirected to the Main Page.

At step 86 the user can elect to add new credit accounts to the SAC system. At step 88 the user views all the possible card attributes (type of account, account number, expiration date, rebate features, etc.) and enters the appropriate ones at step 90. At step 92 (FIG. 5C) the card account is validated (details in FIG. 8). The returned information is matched to the user input information in step 94. If there is a mismatch, the user receives an error message (step 96) and is returned to the modify screen for another try. After a predetermined number of attempts the user is logged out of the system and the account may be inactivated pending proof that the user is legitimate. If the information matches, it is written to the SAC database (step 98) and the updated card list is displayed (step 100) and the user is redirected to the User's Main Page.

The user may elect to modify the attributes of an existing card (step 102); for example updating the expiration date. At step 104 the user selects the card to be modified and at step 106 the modifications are input. The new information is verified with the credit card company at step 108, and the returned information is matched to the input information at step 110. A failure to match (step 112) results in an error message and a return to the modify screen 106 for an attempt to correct the problem. Continued rejection may result in the SAC account being inactivated until the discrepancy is resolved with the user. If the data match, the changes are written to the databases at step 114, the updated card information is displayed (step 116), and the user is returned to the User's Main Page.

At step 118 the user can choose to modify the priority order in which the various registered accounts are used for a purchase. At step 120 the user is permitted to change the priority order (for example, by dragging the accounts up or down the list). Step 122 checks to see if the user has made any changes in the priority. If changes have been made, the changes are written to the databases at step 124, and a refreshed list is displayed at step 126 so that the user can be certain the changes have been processed.

At step 128 the user can elect to view the various incentives that have been made available by the credit providers. At step 130 the user elects an incentive. At step 132 the system checks the incentive data against the user data in the database to make certain the user qualifies; this decision may also be confirmed by checking with the credit provider. At step 134 the verified incentives are recorded in the databases, and at step 136 the updated list of chosen incentives are displayed for confirmation purposes.

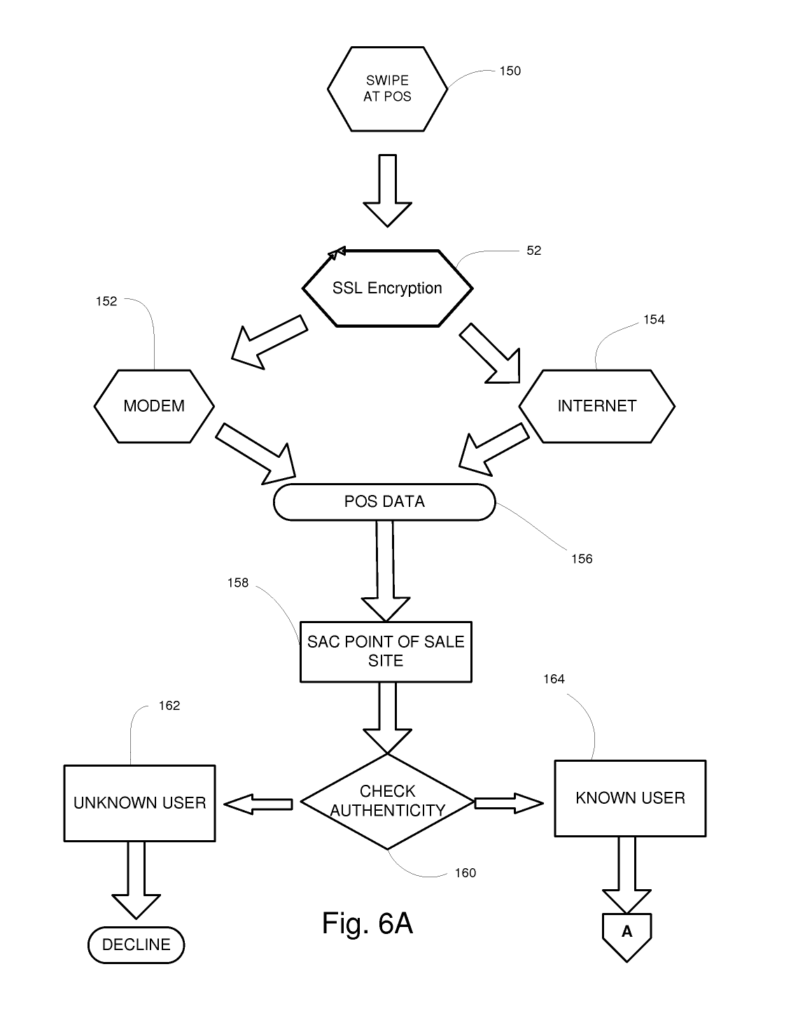

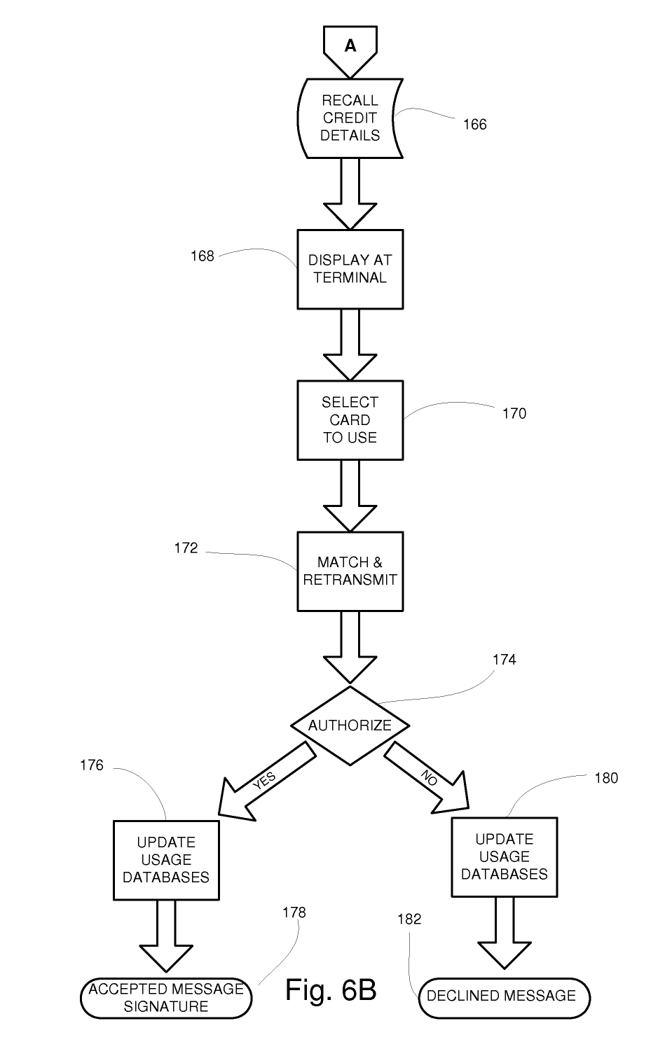

FIG. 6 is a flow chart showing the details of a POS purchase using the inventive SAC card. At step 150 the card is swiped at a POS like any ordinary credit card. As explained before, the user must enter a password. All of the user and sales data are encrypted (step 52) and sent by modem (step 152) (traditional POS systems) or over the Internet (step 154). The POS data 156 are received by the SAC POS site 158 and an authenticity check is made at step 160. An unknown user (step 162) is declined. If the user is known (step 164), the details of the users account are recalled (step 166) and transmitted for display (step 168) at the POS terminal where the user selects an account to use (step 170). This information is sent to SAC (step 172) and the purchase is authorized at step 174. All of this data flow back and forth is encrypted but that is not shown in the diagram for the sake of simplicity. Assuming the selected account has adequate credit the databases are updated (for later reconciliation and fund transfer) and an acceptance message is sent to the POS terminal (step 178). The user signs the credit slip and departs with the purchase. If the selected account does not authorize, this information is noted in the databases (step 180) and a “decline” message is transmitted to the POS at step 182. If the user has more than one registered account, it is likely that another account would be used in lieu of declining the purchase. Depending on the priority scheme the user has in place in the account, the user might or might not be asked to authorize the use of a secondary credit account.

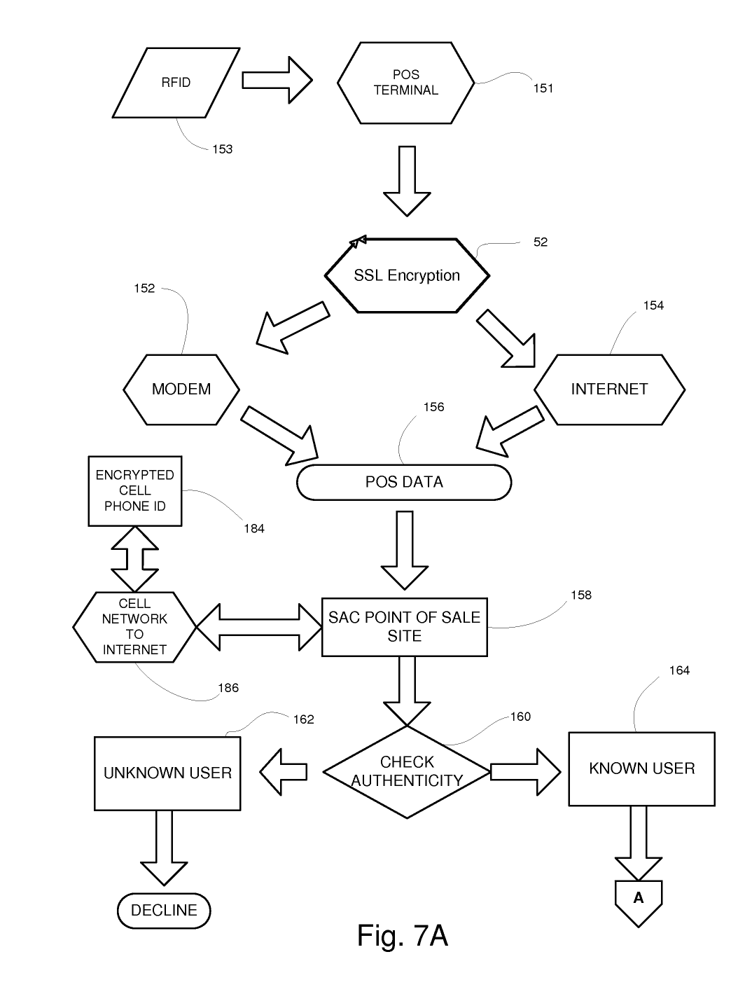

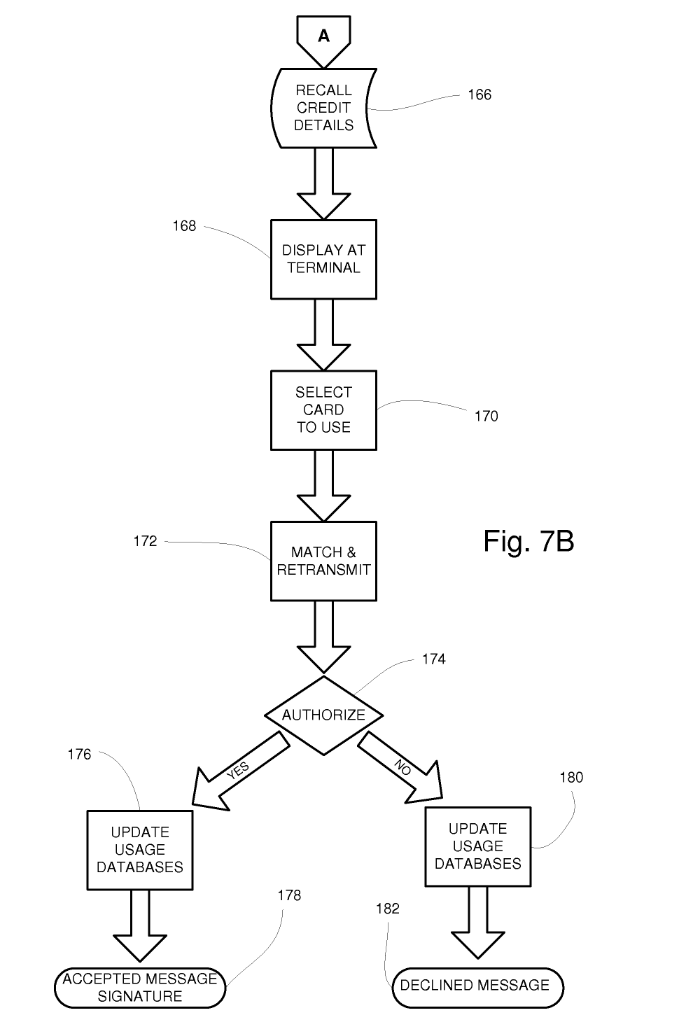

FIG. 7 shows a diagram that is almost identical to FIG. 6; however RF (radio frequency) devices take the place of the SAC card. A great advantage of the SAC card over the prior art is that only a single credit card need be carried. An RF device obviates the need even for that. In one possible scenario the user carries an RFID device in lieu of the SAC card. This device contains an encrypted version of the SAC card number. When this device is interrogated by the POS terminal, this number is entered into the data stream and is transmitted to the SAC point of sale site 158 as in FIG. 6. It is likely that the RFID token would be similar in function to the RFID tags that are increasingly being place in merchandise because the POS is already being equipped to handle such data interrogation. Alternatively, the token could use Bluetooth, WiFi or other RF technology (an “RF token”) to transmit the data. The beauty of this solution is that the user can keep the token securely hidden on their purchase. The user simply makes the purchase, enters the password and everything happens just like a SAC card has been presented. In an alternate system the user's cell phone becomes the RF the token. The cell phone is first registered with SAC so that the cell phone number is associated with an encrypted version of the SAC account number. When the user makes a purchase, the user activates the cell phone 184, enters the password and the encrypted information passes through the cell network to the Internet (step 186) and then to the SAC site 158. Meanwhile at the POS the user inputs the password and the two data streams are matched at the SAC site 158. Thereafter the system progresses as explained in reference to FIG. 6. With this system the user needs only a registered cell phone. There is no card or token to be lost or stolen. Without the SAC password, the cell phone cannot be used to make SAC purchases.

FIG. 8 is a diagram illustrating how SAC interacts with the Credit Card Company to obtain sales authorization and account information. The data from SAC (step 190) contains either account information with a request for credit limits and balances (data) or sales information with sales amount and account identity with a request for sales authorization. This data is encrypted (step 52) and passes by modem 152 or Internet 154 to the credit card company site 192. At step 194 it is determined if the request is for account data or sales authorization. If the request is for data (step 196), validity of the account is verified at step 198 (FIG. 8B) and if the account is valid, the requested data (step 200) are encrypted and sent back to SAC (step 210). At step 211 SAC determines what kind of data have been received. The data are found to represent card account data (balances and limits) at step 212 and the user account records are updated accordingly at step 214. If the account is determined not to be valid at step 198, this information 208 is also relayed to SAC and may affect the user's account standing as explained above.

If the data are found to represent a sales authorization request at step 202, the purchase amount is compared to the account records at step 204 and either an authorization 206 or a failure 208 are issued. These data are returned to SAC as explained in regards to the account information request above. At SAC 210 a determination is made (step 211) as to the request type and at step 216 a sales authorization request is handled with the appropriate message (accept or decline) being returned to the POS at step 218. The details of this part of the process are shown in FIG. 6.

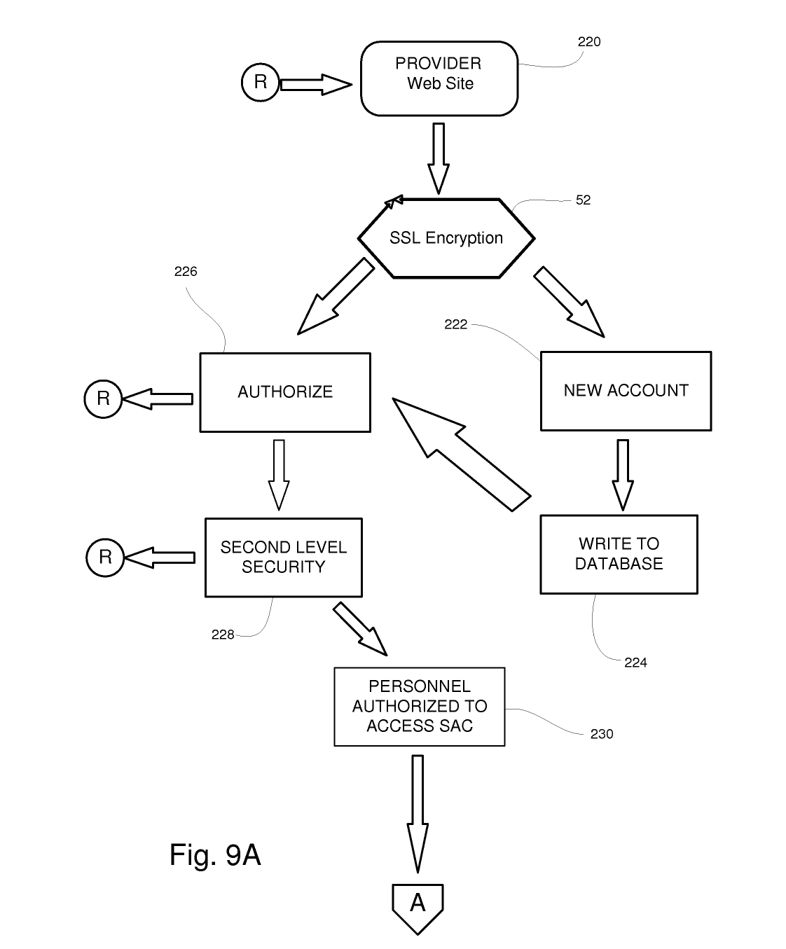

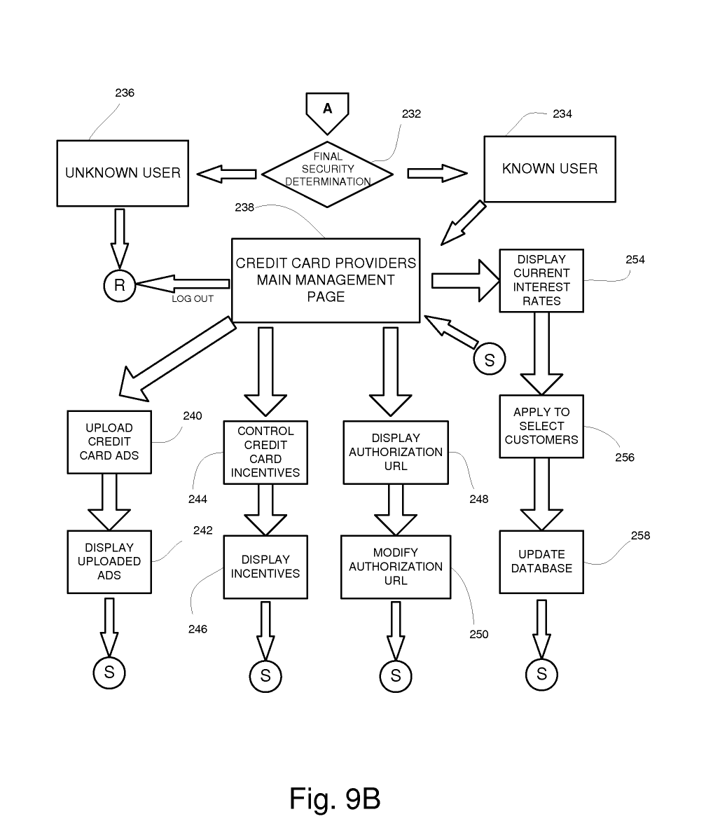

FIG. 9 shows the processes behind a web site 220 operated by Sac for the benefit of the credit providers. To use the site 220 the provider first establishes a new account (name, password, etc) at step 222. These data are recorded in the SAC database at step 224 and the new user is passed to the normal authorization process 226. The user then provides its account name and is passed on to an optional second level of security (step 228) where queries, etc. can be used to verify the bona fides of the user. At step 230 the user is passed on to step 232 for a final determination of unknown user (step 236) versus known user (step 234). Known users are directed to the Providers Management Page 238. The provider may chose to upload (step 240) new advertisements for display on the SAC user web site and on the SAC POS terminals. After upload the new ads are displayed at step 242 for user verification.

The provider may also elect to alter and/or input new credit card incentives at step 244. Again, the input incentives are displayed at step 246 for user verification. The provider can control the URL by which SAC contacts it for verification/data requests through display (step 248) and modification (step 250). Finally at step 254 the provider can inspect a display of its currently offered interest rates (along with the account criteria for each rate). The rates can be modified and applied to specific customer accounts at step 256 after which the SAC databases are accordingly updated at step 258.

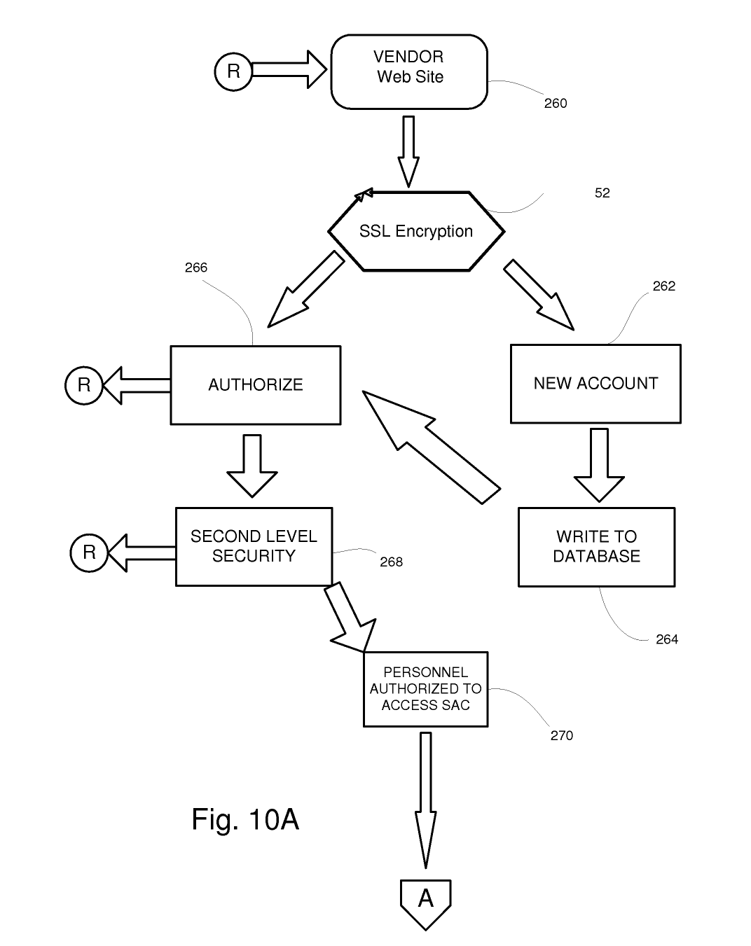

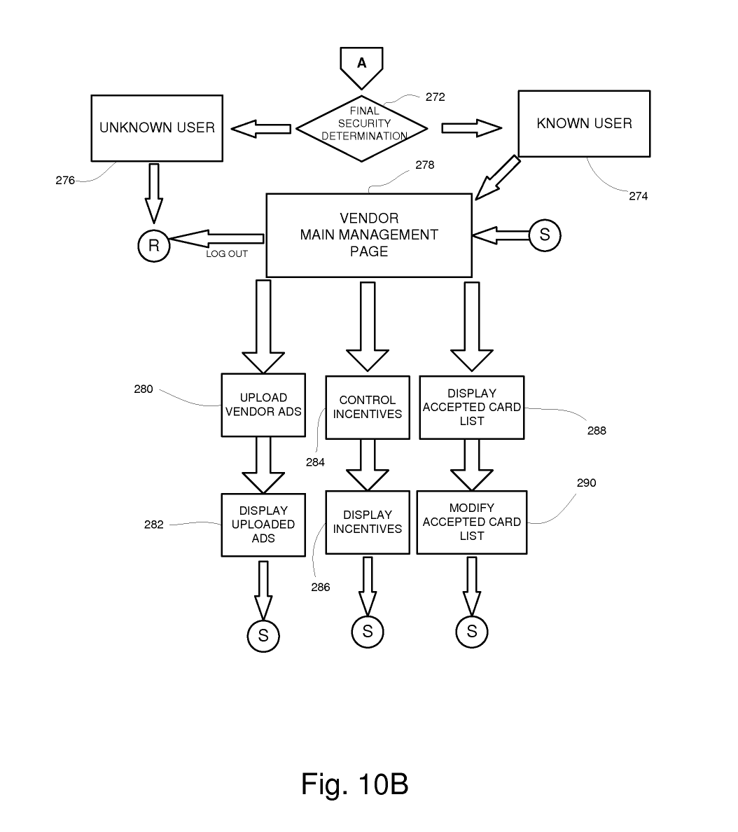

FIG. 10 shows a SAC operated site 260 for use by the vendors that use the SAC services and the processes underlying the site. The new account and login procedures (steps 262-272) are analogous to steps 222-232 discussed above in relation to FIG. 9. A properly authorized user reaches the Vendor Management Page 278, There the vendor can upload new advertisements (step 280) and display them for verification purposes (step 282). These ads will be displayed on the SAC user site and on the POS screens. At step 284 the vendor can input incentives and display them at step 286. These incentives will appear on the POS screens and may also be printable as coupons. At step 288 the vendor can view its list of accepted credit cards and then modify the list at step 290.

In addition, there can be competition from credit card companies-merchants could receive revenue from credit card companies in return for having their accounts show up at the top of a list, or in a strategic position agreed upon by both the merchant and the credit card company. Credit card companies could pay the merchant fees to lock in top acceptance position for set periods of time. Alternatively, a credit card company can offer the user special low rates for allowing the particular account to occupy the number one SAC position—perhaps for the duration of the special low rate. There could also be special offers—rebates or miles or the like for selecting the featured account. The merchant (or SAC) also receive revenue from ads that appear on part of the screen. If the consumer is willing to view such ads, the SAC account fees can be reduced; if the consumer takes advantage of a certain number of special credit offers featured on the site, the SAC fees can be waived. The display can also be used for coupons which would appear on the screen and which could be selected and printed for the consumer. For example, Pepsi could sponsor a coupon for buy one 6-pack, get one free—the consumer could select the coupon, and it would print at the register for later redemption. No more printing of multiple unwanted coupons at checkout stands. In addition, since many POS systems are fully “aware” of items being currently purchased, if any of the offered coupons applied to items being purchased in that sales transaction, there could be instant coupon redemption with no need to even print a paper copy of the coupon.

The SAC card can also operate at single use “old fashioned” vendors, like restaurants. When the consumer sets up his account at the web site, the consumer sets up the priority order in which accounts are to be accepted. To avoid the problem where some “old fashioned” vendors do not have the means to enter passwords, the consumer could also set up the SAC account to allow password free purchases only at certain types of venues (for example restaurants). After the SAC card is swiped at an “old fashioned” POS at a restaurant, the account charged is the one logged as the first to accept—for example, American Express. If however, the restaurant does not accept American Express, then the SAC site would automatically choose the second in line account-MasterCard. The lack of password protection at a restaurant can be considered an acceptable risk since it is difficult for credit card thieves to turn a profit by purchasing restaurant meals.

Specialty stores, such as Banana Republic or Bloomingdale's often offer a 5% or 10% discount on current purchases for opening a new account. This can be readily accommodated by the SAC POS screen, which can have an entry to allow the consumer to select ‘add new account’. The consumer address information is automatically transferred from the SAC servers to the specialty store computers, thereby avoiding the errors that happen when such data must be input a new. The new account number will be added to the SAC account list and the discount applied. This process saves time and money for both the consumer and the merchant.

Parents can give their children SAC accounts with selected appropriate accounts registered. For example, an offspring heads off to college-a parent can issue them a SAC card linked to the parent's VISA account, gasoline account, AAA account, Grocery club account number, and so on. Further, the parent can retain the password to the SAC account and can set up strict spending limits on each of the accounts to control overall spending.

The consumer is able to select various custom looks for their SAC card, for example, flowers, dogs, landscapes, sunsets etc. The SAC could come in many different shapes and sizes, ranging from standard credit card size to a square, small rectangle. All that is necessary is a machine readable account number for accessing a POS. The SAC could be practically any shape or size as long as it provided means for identifying itself to a POS system; with a radio frequency transmitter for scanning purposes a key chain sized device would be sufficient. However, to access “old fashion” systems as found at many restaurants a SAC in the form of a current credit card would be most useful.

The SAC card provides enhanced security because it requires a PIN for the majority of purchases. Further, if the SAC card/device is stolen, none of the credit/debit or club account information is breached because none of that information is stored on the SAC card. All the credit/debit information is maintained at the SAC secured web site. A single call to SAC will instantly inactivate the stolen SAC card. The consumer has only to get a new SAC card and SAC account number; all the credit/debit and club accounts remain secure. Further, a wary consumer can set certain predetermined limits on linked accounts so that if unusual spending activity occurs, the SAC card is automatically inactivated. Further, because the SAC site can see the total picture of the consumer's spending, it can more readily detect fraudulent use than a single credit card company. Every SAC user will be given the choice to allow SAC to challenge or even suspend account use if the pattern of use is abnormal. The incredible savings in fraud reduction will motivate credit card companies to support and even subsidize the SAC system. Because none of the underlying accounts are compromised, it is simple for the consumer to receive a replacement SAC card with a new number and password.

Currently, few people carry all their active credit/debit or specialty cards with them. With SAC, credit/debit card companies can be assured that their accounts will be carried with the consumer at all times, thus giving the credit/debit card companies a greater chance of their accounts being used more often. Also, the credit card company that pays a merchant for its accounts/logos to be at the top of list will have a guaranteed higher rate of charges. This gives the credit card companies two very important advantages. First, the consumer has their account with them all the times, and second the credit card company's logo is most visible at the top of the list.

It will be appreciated that once the SAC system provides a unified vehicle for multiple credit accounts, the options available to the credit consumer are enormous. Prioritizing accounts and placing various spending limits on accounts has already been mentioned. In addition, the consumer can receive various special credit offers from the credit card companies with which the consumer has accounts—for example by means of direct links to the credit card company web sites placed on the consumer's SAC account web page. By means of the SAC system the consumer can accept the offers and can transfer balances to the most advantageous accounts. This process can even be automated so that balances are automatically transferred to the most favorable account during the life of the offer and then moved to the then most favorable account when the offer terminates. This stimulates competition between credit card companies and avoids the trap where a consumer transfers a balance to get a favorable rate, forgets about the expiration of the favorable rate and winds up paying an outrageous rate on the transferred balance. All these features and more are available because the SAC system replaces multiple separate credit cards with a single secure card that accesses and manages all a consumer's credit accounts.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

I claim:

1. A method for managing a plurality of consumer credit accounts comprising the steps of:
creating a user account through a secure site that can be accessed by a network;
registering at least one credit account by means of the user account and the secure site so that credit account access and verification data from a credit provider of the at least one registered credit account can be accessed by the secure site;
providing a physical account identifier which functions as a token to access the credit accounts registered on the secure account;
presenting the token at a point of sale to initiate a sales transaction; and
consummating the sales transaction by routing said transaction to the credit provider of a registered account having sufficient available.

2. The method according to claim 1 wherein the step of consummating further comprises selecting a registered account that has sufficient available credit to accommodate the sales transaction and routing said transaction to the selected account.

3. The method according to claim 1 further comprising a step of periodically accessing sites operated by credit providers of registered credit accounts to establish and update records of credit limits and current balances for each registered credit account.

4. The method according to claim 1 further comprising a step of prioritizing the registered credit accounts so that in the consummating step the financial transaction is routed to the account with the highest priority that has sufficient available credit to accommodate the financial transaction.

5. The method according to claim 1 further comprising a graphical display of the registered accounts at a point of sale when the token is presented.

6. The method according to claim 5, wherein the graphical display presents third party advertisements.

7. The method according to claim 5, wherein the graphical display indicates the available credit level of each registered account.

8. The method according to claim 5, wherein the graphical display is used to select to which of the registered accounts the financial transaction is routed.

9. The method according to claim 5, wherein the step of presenting the token further includes a security step.

10. The method according to claim 9, wherein the security step comprises one of presenting a password and providing biometric data.

11. The method according to claim 1, wherein the token is selected from the group consisting of a credit card, a card containing an embedded microchip, an RFID device, an RF token and a cell telephone.

12. The method according to claim 1, wherein the step of consummating comprises the sub-steps of transmitting point of sale data related to the financial transaction and to the token to the secure site, checking the authenticity of the token, transmitting the sale data from the secure site to the credit provider for authorization if the token is authentic, sending an authorization from the credit provider to the secure site if the financial transaction is authorized and sending a message to the point of sale indicating the authorization whereby the financial transaction is consummated.

13. The method according to claim 12, wherein the secure site transmits the sales data to the registered credit account having the highest priority if the registered accounts have been prioritized and having sufficient available credit to accommodate the sales transaction.

14. The method according to claim 12, wherein the secure site transmits the sales data to the registered credit account which has been selected at the graphic display.
